(19) United States
(12) Patent Application Publication
(10) Pub. No.: US 2018/0178336 A1
(43) Pub. Date: Jun. 28, 2018

(54) Magazine for Storing Bar-Shaped Workpieces for a Machine Tool

(71) Applicant: Walter Maschinenbau GmbH, Tübingen (DE)

(72) Inventors: Lukas Gussmann, Kirchentellinsfurt (DE); Daniel Schindler, Weil i.S. (DE)

(21) Appl. No.: 15/324,593

(22) PCT Filed: Jun. 10, 2015
(86) PCT No.: PCT/EP2015/062969

§ 371 Date: Jan. 6, 2017

(30) Foreign Application Priority Data
Jul. 9, 2014 (DE) 10 2014 109 611.8

(51) Int. Cl. B23Q 3/04

(52) U.S. Cl. CPC B23Q 3/04

(57) ABSTRACT

A magazine for storing shaft-shaped workpieces includes at least one receiving body (12) with at least one receiving hole (15) for insertion of an end section (11a) of a shaft-shaped workpiece (11). The end section (11a) that has been inserted in a receiving hole (15)—viewed along the longitudinal axis (L) of the workpiece (11)—is shorter, and, in particular, shorter by the factors three to five, than the remaining section of the workpiece (11) that adjoins the end section (11a). The receiving body (12) is configured in such a manner that, in operating position of the magazine (10), the center axes (M) of the at least one receiving hole (15) and the vertical (V) subtend a first angle of inclination (β). As a result of this, it is achieved that the workpieces (11) tilt in a defined tilt direction (K) and do not hit each other.

The invention relates to a magazine for storing shaft-shaped workpieces. Such a magazine is required, for example, for storing workpieces that are to be machined or have already been machined on a machine tool. Preferably, the magazine is designed in such a manner that the workpieces can be individually removed from the magazine or set in the magazine by an automated gripper.

A magazine for shaft-shaped workpieces has been known from publication DE 33 01 314 A1, for example. In that case, a circular palette provided with one or more annular grooves is provided. Receiving holes for storing shaft-shaped workpieces are provided in these grooves, wherein the end sections of the workpieces are inserted in the respectively associate receiving hole for this purpose.

For technical reasons, there always exists a play between the receiving holes and the end sections of the workpieces. This play must be sufficiently large in order to allow an automated removal and insertion of the end section of the workpieces from and into the receiving holes. The greater the play is, the simpler is the handling. However, this play also causes the center axis of the receiving holes to not necessarily be in alignment with the longitudinal axis of the stored workpieces. The greater the length of the workpiece is, the greater is the risk that the workpieces come into contact with each other at the end opposite the receiving hole, which may potentially lead to undesirable traces or damage on the surface of a structure that is to be machined.

In order to avoid contact, an appropriately large distance between the receiving holes must be selected—independently of the play. However, this solution has the disadvantage that the magazine for storing a certain number of workpieces takes up much space that frequently is not available or too expensive.

Therefore, it may be considered the object of the present invention to provide a magazine that is particularly suitable for the individual, separate storage of long, shaft-shaped workpieces.

This object is achieved by a magazine displaying the features of Patent claim 1. The magazine comprises at least one receiving body. The at least one receiving body has at least one receiving hole and, preferably, several receiving holes. In particular, the several receiving holes may be arranged in rows and/or columns next to each other. Each receiving hole has an orifice on one upper side of the receiving body. An end section of a shaft-shaped workpiece that is to be stored can be inserted through this orifice into the respective receiving hole.

On the receiving body there is provided at least one arrangement means. The at least one arrangement means is disposed for arranging the receiving body in its operating position, in particular in the area of the machine tool or a gripper device. For example, an arrangement means may be provided, whereby said means can be used to place the receiving body on a flat, preferably horizontal, storage surface. Additionally or alternatively, an arrangement means may be provided on the receiving body in order to arrange the receiving body on an attachment surface, for example, a magazine carrier.

The at least one arrangement means defines a reference plane. If there exist several arrangement means, different reference planes can be defined by the respective arrangement means. If several arrangement means, each having a reference plane, are provided, the different reference planes are preferably oriented parallel to each other. Preferably, the reference planes are oriented parallel to a storage surface and/or an attachment surface, for which the respective arrangement means is provided.

The at least one receiving hole has a center axis that extends centrally along the receiving hole. The center axis of the at least one receiving hole intersects the at least one reference plane at an angle of inclination that is different from a right angle. For example, the angle of inclination may be 75° to 85°.

In the operating position of the magazine, the reference plane is preferably oriented in horizontal direction. Therefore, the center axis of the at least one receiving hole extends at an acute angle relative to a vertical axis. This acute angle between the center axis and the vertical axis may be in the range of 5° to 10°. Due to this measure, a workpiece inserted in the receiving hole is tilted in a preferred direction. Despite a play between the end section of the workpiece and the receiving hole, it is possible—in this manner—to avoid a contact between several workpieces that are arranged in closely spaced adjacent receiving holes. The reason being that all workpieces are tilted relative to a vertical or horizontal plane in a defined direction and, preferably, in the same direction. Consequently, it is possible, on the one hand, to arrange a plurality of shaft-shaped workpieces in a small space and, on the other hand, to still avoid any inadvertent contact among the workpieces.

If the reference plane defined by the at least one arrangement means clearly deviates from a horizontal plane and, for example, subtends angles of more than 5° to 10° with the horizontal plane, the orientation of the center axis relative to the reference plane must be selected in such a manner that, in the end, an acute angle of inclination results between the center axis of the at least one receiving hole and a vertical. Ideally, this acute angle of inclination amounts to 5° to 10°. As a result of this, on the one hand, a tilting in a defined direction is ensured and, on the other hand, little space is needed for the arrangement or storage of the workpieces in both horizontal directions.

Preferably, each workpiece is inserted in the associate receiving hole. Clamping means that effect a non-positive clamping of the workpiece on the receiving body do preferably not exist. This simplifies the handling of the workpieces when they are being inserted and removed. An automated gripper need not operate clamping means and may thus be designed in a very simple manner.

Preferably, it is intended that the orientation of the center axis of the at least one receiving hole is fixedly set relative to the reference plane and cannot be changed by driving means.

Preferably, the center axis of the at least one receiving hole is oriented at a right angle relative to the upper side of the receiving body. The upper side of the receiving body preferably extends in one plane that, accordingly, is inclined relative to the reference plane and, in operating position, extends inclined relative to the vertical.

The at least one receiving hole may have on its end opposite the orifice a bottom and at least one stop. The at least one receiving hole is preferably configured as a pocket hole, in particular as a pocket bore.

In the exemplary embodiment, the receiving hole has a cylindrical contour that may have the form of a circular cylinder.

In particular, each receiving body has several receiving holes. The magazine may also comprise several receiving bodies. Preferably, the receiving holes of a receiving body and/or the receiving holes of several receiving bodies are arranged in rows and/or columns, for example in a matrix-like manner. Furthermore, it is advantageous if all center axes of the receiving holes of a receiving body and/or the receiving holes of all existing receiving bodies are oriented parallel with respect to each other.

All existing receiving holes of a receiving body and/or all existing receiving bodies preferably have the same contour. This makes sense when a plurality of the same type of workpieces are to be stored.

In one exemplary embodiment, the receiving body has at least one receiving section in which the at least one receiving hole is arranged, it being made in one piece of a uniform material without seams and joints. In so doing, the receiving holes may be provided, for example, as boreholes in the receiving body.

Alternatively thereto, a receiving body or the receiving section may also be composed of several individual parts. For example, several plate-shaped elements, at least one of these having a passage bore and/or a pocket bore, may represent the receiving section or the receiving body with the at least one receiving hole.

In a preferred exemplary embodiment, the receiving body has a first arrangement means or a first arrangement device that is designed to arrange the receiving body on a magazine carrier. The magazine carrier may be arranged, for example, by means of a plate-shaped part with an attachment surface and be disposed for the accommodation of preferably several receiving bodies of the magazine. The magazine carrier may be a component of a magazine that has several receiving bodies that, together, support these receiving bodies.

The first arrangement means may preferably comprise an abutment surface. The abutment surface is preferably arranged on the underside of the receiving body opposite the upper side and may be a component of the receiving body or be a separate part of the first arrangement means. In such a first arrangement means, it is the abutment surface that defines the reference plane.

In one advantageous embodiment, the first arrangement means may have a positioning means. The positioning means is disposed to determine the relative position between the receiving body and the magazine carrier—in particular parallel to the reference plane—together with a corresponding positioning counter-means. The positioning means may be, for example, a positioning projection and/or a positioning recess, wherein the positioning counter-means is configured so as to be appropriately complementary. The positioning means may be arranged, at least partially, outside the reference plane defined by the first arrangement means, i.e., for example at a distance with respect to this reference plane, or extend through this reference plane.

In a preferred exemplary embodiment, the at least one receiving body comprises a second arrangement means and a second arrangement device, respectively, that is (are) configured to place the receiving body on a storage surface. The second arrangement means is different from the first arrangement means. It is possible to provide only one of the two arrangement means, in which case, preferably, both arrangement means are provided on the receiving body.

In a preferred exemplary embodiment, the second arrangement means has at least three feet whose free ends are arranged in a joint storage plane. In this embodiment, this storage plane defines the reference plane for the second arrangement means.

In one exemplary embodiment of the receiving body that comprises the first, as well as the second, arrangement means, the second arrangement means is configured in such a manner that the first arrangement means does not come into contact with the storage surface when the receiving body is placed on any flat storage surface. In other words: The first arrangement means is without effect, as it were, if the receiving body is placed on a flat storage surface via the second arrangement means. In contrast, the first arrangement means is disposed for arranging the receiving body on the magazine carrier.

For example, considering the exemplary embodiment, the abutment surface and/or the positioning means of the first arrangement means are arranged completely above the storage plane. This is understood to mean a position of the abutment surface or the positioning means that is located between the storage plane and a plane describing the position of the upper side of the receiving body.

Advantageous embodiments of the invention can be inferred from the dependent patent claims as well as from the description and the drawings. Hereinafter, preferred individual exemplary embodiments are explained with reference to the appended drawings. They show in

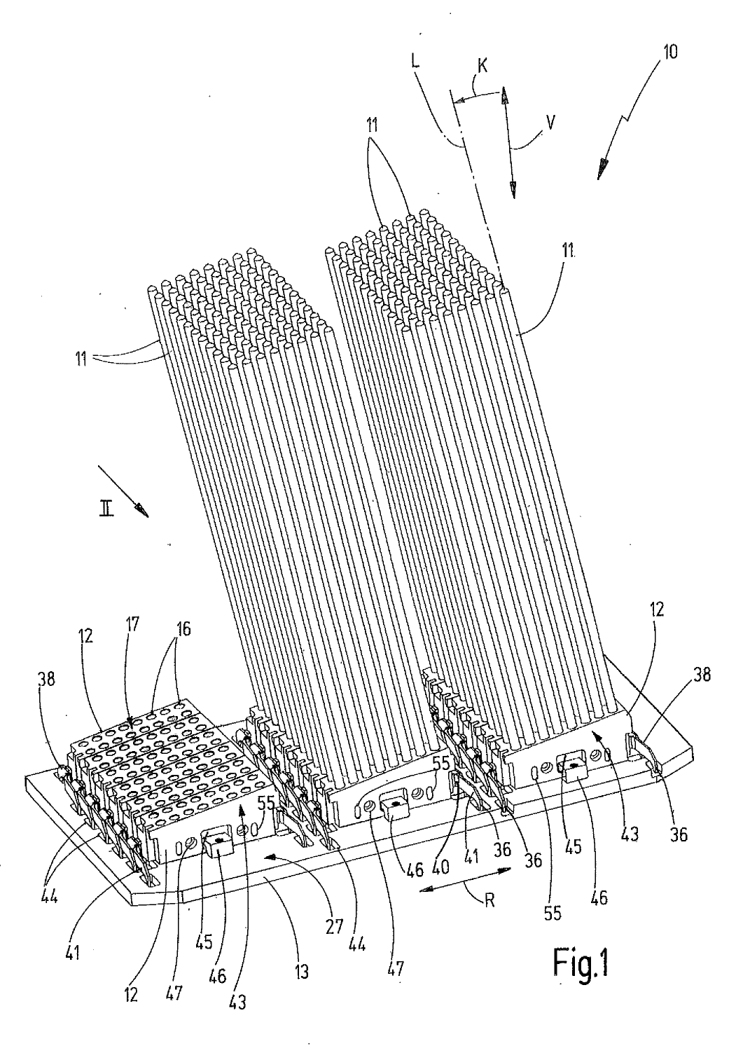

FIG. 1 a perspective view of an exemplary embodiment of a magazine with several receiving bodies and one magazine carrier;

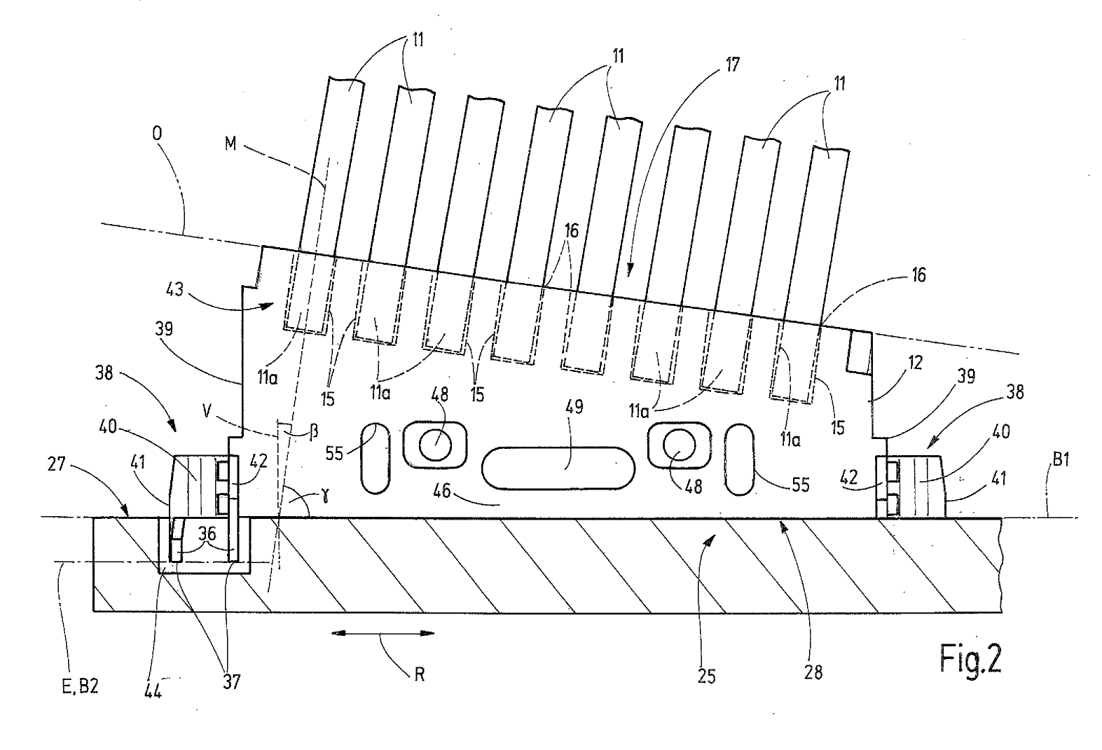

FIG. 2 a lateral view along arrow II in FIG. 1 of the receiving body of FIG. 1;

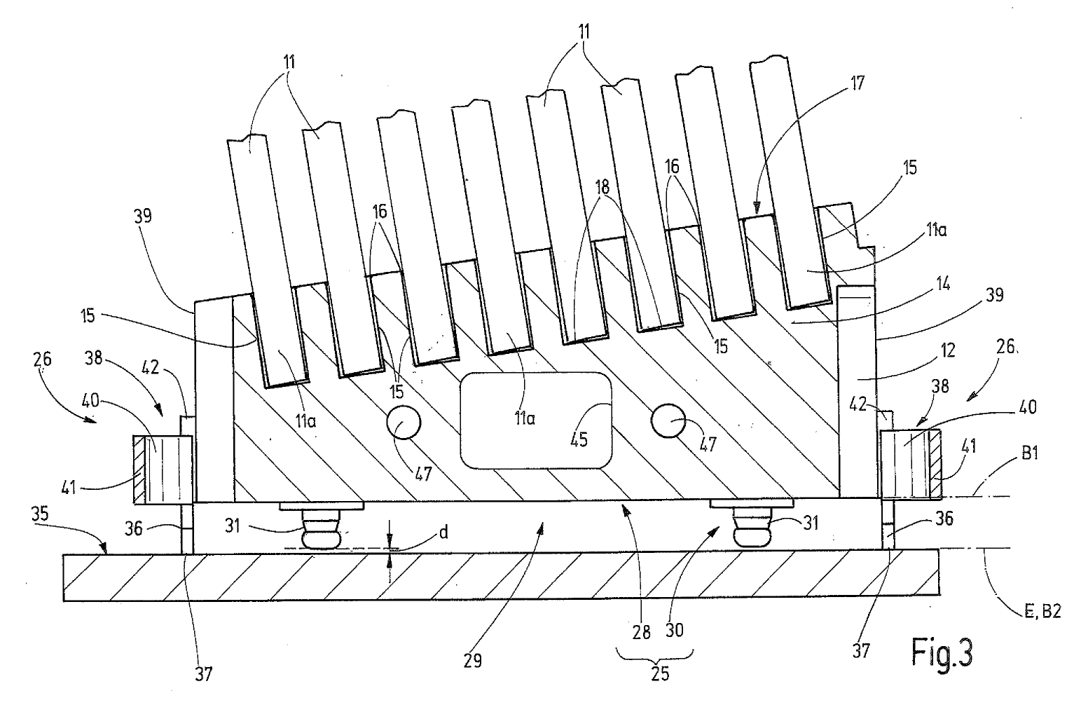

FIG. 3 a cross-section through a receiving body of the magazine of FIG. 1;

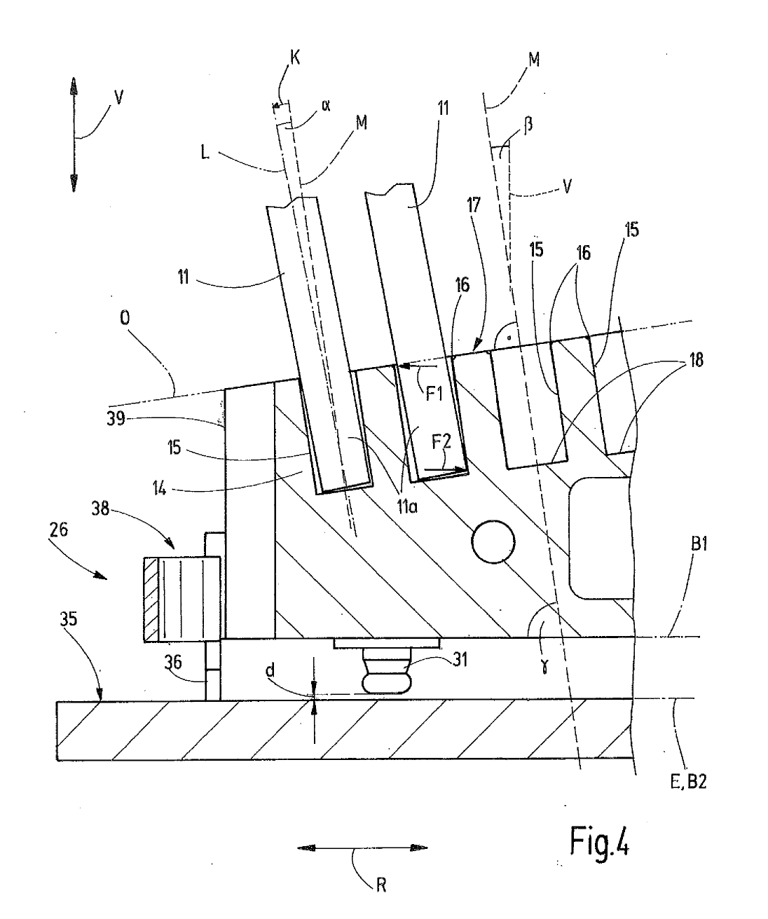

FIG. 4 a partial view of the receiving body of FIG. 3;

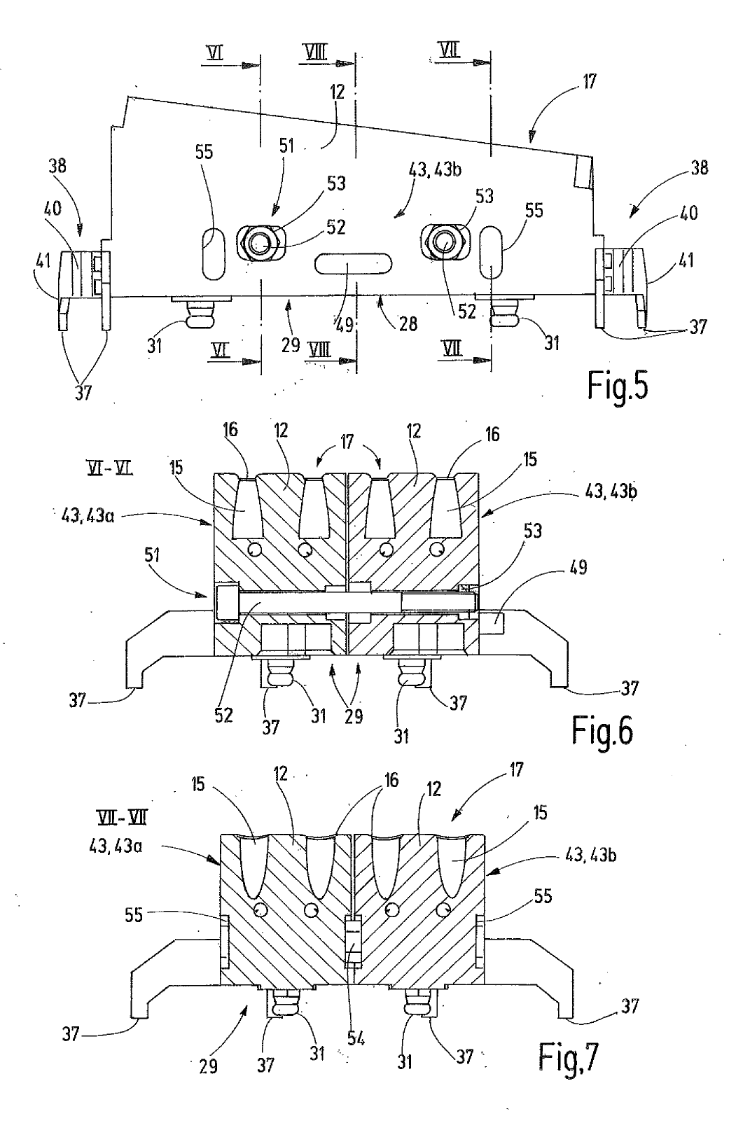

FIG. 5 a lateral view onto a transverse surface of a row of two receiving bodies as in FIGS. 2 to 4;

FIG. 6 a sectional view along line of intersection VI-VI in FIG. 5 of a row of two receiving bodies as in FIG. 5;

FIG. 7 a sectional view along line of intersection VII-VII in FIG. 5 of a row of two receiving bodies as in FIG. 5; and

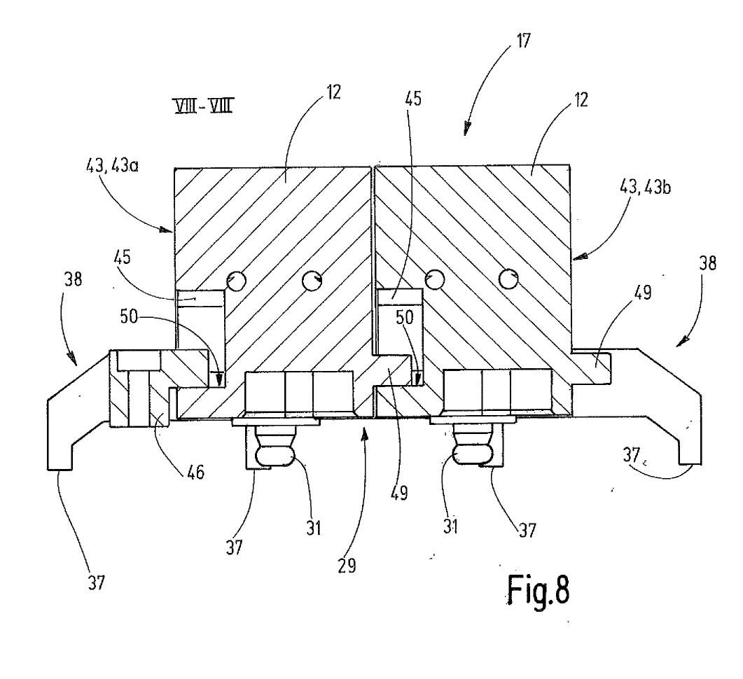

FIG. 8 a sectional view along line of intersection VIII-VIII in FIG. 5 of a row of two receiving bodies as in FIG. 5.

FIG. 1 shows an exemplary embodiment of magazine 10. The magazine 10 is disposed for storing or warehousing shaft-shaped workpieces 11 that have a cross-section that is cylindrical at least in sections or has the shape of a circular cylinder, for example.

The magazine 10 is arranged in the vicinity of a machine tool or a gripper device, or on a transfer unit. Non-machined and/or machined workpieces 11 can be stored in the magazine 10.

The magazine 10 comprises at least one and, in accordance with the example, several receiving bodies 12. The receiving bodies 12 are identical and shown more accurately by FIGS. 2 to 4. In accordance with the example, all receiving bodies 12 are arranged on a shared magazine carrier 13. As illustrated, the receiving bodies 12 may form one or more rows, wherein adjacent receiving bodies 12 in each row abut directly against each other.

Each receiving body 12 has a receiving section 14 in which several receiving holes 15 are located. In accordance with the example, all receiving holes 15 have the same contour which, in the described exemplary embodiment, has the shape of a circular cylinder. In modification thereof, other cylindrical contours could also be provided.

At least the receiving section 14 or also the entire receiving body 12 consists of a uniform material and is made in one piece, without seams or joints.

The receiving holes 15 are configured in the form of pocket holes in the receiving section 14. In accordance with the example, each receiving hole 15 has a cylindrical hole wall and extends to a bottom 18—starting from an orifice 16 on the upper side 17 of the receiving body 12. The receiving hole 15 is thus accessible at the orifice 16 on the upper side 17. The length of the receiving holes 15 between the respective orifice 16 and the respective bottom 18 is the same, in accordance with the example.

Each receiving hole 15 has a center axis M and extends along the center axis M (FIG. 4). The center axis M is oriented at a right angle with respect to a plane O, in which the orifices 16 are located or along which extends the upper side 17 of the receiving body.

For storage in the magazine 10, the end section 11 of the shaft-shaped workpieces 11 is inserted in the respectively associate receiving hole 15. In order to make possible the insertion and also the removal 11 of the workpieces into and from the receiving hole 15, there exists a play between the end section 11a and the receiving hole 15, viewed radically toward the center axis M. In the case of cross-sections having the form of a circular cylinder as is true with the exemplary embodiment described here, the outside diameter of the end section 11a is thus smaller than the inside diameter of the receiving hole 15. Due to this reason, the shaft-shaped workpieces 11 can tilt relative to the center axis M of the receiving hole 15, so that there exists a tilt angle a between the longitudinal axis L of a workpiece 11 and the center axis M of the associate receiving hole 15, as is schematically illustrated in FIG. 4.

In the case of magazine 10 or the at least one receiving body 12 in operating position, the center axis is inclined with respect to a vertical V about a first angle of inclination β. Due to the force of the weight of the shaft-shaped workpiece 11, the end section 11a of said workpiece is pushed against the receiving body 12 in a tilt direction K with a first force F1 at a point on the orifice 16 and against the tilt direction K with a second force F2 on the inside of the receiving hole 15, adjacent to the bottom 18. The workpiece 11 is wedged in the receiving hole 15, as it were. Due to the inclined position of the center axis M of the receiving hole 15 relative to the vertical V in operating position of the magazine 10, the stored workpiece 11 tilts in a defined tilt direction K—namely in the vertical plane away from the vertical V—in which the center axis M of the receiving hole 15 is located.

The end section 11a of a workpiece 11 that has been inserted in a receiving hole 15—viewed along the longitudinal axis L of the workpiece 11—is shorter and, in particular, shorter by at least the factor of three to five—than the remaining section of the workpiece 11 that adjoins the end section 11a.

In accordance with the example, all center axes M of the receiving holes 15 are oriented parallel to each other in a shared receiving body 12. As a result of this it is ensured that all workpieces 11 tilt in the same tilt direction K and extend essentially parallel to each other, this being particularly obvious from FIG. 1. Furthermore, according to the example, also the center axes M of all receiving holes 15 of several and, preferably, of all receiving bodies 12 are oriented in parallel direction.

The inclined position of the center axes M relative to the vertical V in operating position of the magazine 10 is achieved in the exemplary embodiment in that, in this operating position, the plane O of the upper side 17 of the receiving body 12 is inclined with respect to the horizontal plane. This is accomplished by a first arrangement means 25 and/or a second arrangement means 26 that is present on the receiving body 12. The first arrangement means 25 is designed for arranging the receiving body 12 on an attachment surface 27 of the magazine carrier 13 (FIG. 2). The first arrangement means 25 comprises an abutment surface 28 on the receiving body 12. The abutment surface 28 extends preferably in one plane and, with the connection with the magazine carrier 13 established, is seated on the attachment surface 27. In accordance with the example, the abutment surface 28 is provided on the underside 29 opposite the upper side 17 of the receiving body 12.

Optionally, the first arrangement means 25 may comprise a positioning means 30. In the exemplary embodiment, the positioning means 30 are two or more pin-shaped positioning projections 31 that engage in corresponding positioning recesses on the magazine carrier 13 when the abutment surface 28 rests on the attachment surface 27. As a result of this, the position of the receiving body 12 can be defined parallel to the attachment surface 28, or to the abutment surface 28, relative to the magazine carrier 13.

The abutment surface 28 of the first arrangement means 25 defines the first reference plane B1. The center axis M of each receiving hole 15 intersects the first reference plane B1 under a second angle of inclination y. In operating position of the magazine 10, the first reference plane B1 is preferably oriented in horizontal direction. In this case, the first angle of inclination β and the second angle of inclination γ add up to 90° (FIG. 4).

In the exemplary embodiment described here, a second arrangement means 26 is provided on the receiving body 12, as described hereinabove. The second arrangement means 26 has at least three and, in accordance with the example, four feet. The free ends 37 of these feet 36 are located in a shared storage plane E. This storage plane E defines a second reference plane B2 for the second arrangement means 26.

In the exemplary embodiment described here, each receiving body 12 has four feet 36, wherein respectively two feet 36 are provided on a shared foot part 38. Two foot parts 38 are provided on opposite lateral surfaces 39 of the receiving body 12 and screwed thereto in accordance with the example. The two lateral surfaces 39 and the two foot parts 38, respectively, are arranged in a direction R at a distance from each other. In this direction R, the two feet 36 of one foot part are also at a distance from each other (FIGS. 1 and 2). This is achieved in that the foot part 38 has a transverse part 40 extending at least also in the direction R starting from the attachment site on the lateral surface 39, said transverse part potentially forming an offset or the like, for example. The transverse part 40 continues in an end part 41 that is at a distance from the lateral surface 39 or the receiving body 12, at which end part one of the two feet 36 is arranged. The respectively other foot 36 of the foot part 38 may be located on an attachment part 42 of the foot part 38, by means of which the foot part 38 is attached to the receiving body 12.

The transverse part 40 and the dimensions of the attachment part 42 and the end part 41 are selected in such a manner that the transverse surfaces 43 of the receiving bodies 12, said surfaces connecting the two lateral surfaces 39, can be placed next to each other and lined up, as it were, as is shown in FIG. 1. In so doing, the end part 41 of the foot part 38 of the one receiving body 12 extends over the neighboring receiving body 12, as can be seen in FIG. 1. The foot parts 38 do not impair the lining up of the receiving bodies 12 due to this, and the feet 36 still have sufficiently large space in the direction R, as well as also in the same plane at a right angle with respect to the direction R, in order to be able to place the receiving body 12 in a stable manner on a storage surface 35.

From FIGS. 3 and 4 it can be inferred that the two reference planes B1, B2 are oriented parallel to each other. The first reference plane B1—viewed in a direction at a right angle with respect to the two reference planes B1, B2—is at smaller distance from the receiving holes 15 of the receiving body 12 than the second reference plane B2. When the receiving body 12 is placed on a storage surface 35, the arrangement means 25 is not active. The abutment surface 28, as well as the positioning means 30 do not extend—starting from the receiving body 12—through the storage plane E and the second reference plane B2 defined thereby. Consequently, the first arrangement means 25 does not hinder the storage of the receiving body 12 outside the magazine carrier 13 on a flat storage surface 35. FIGS. 3 and 4 schematically show a distance d between the positioning projections 31 and the storage plane E and the second reference plane 2, respectively.

The abutment surface 28 supported by the attachment surface 27 of the magazine carrier 13 is disposed for the arrangement or attachment of the receiving body 12 on the magazine carrier 13. In the region of the foot parts 38 or the feet 36, there are recesses 44 provided in the magazine carrier 30, said recesses being recognizable in FIGS. 1 and 2. The feet 36 come into engagement with a respectively associate recess 44, without determining the position of the receiving body 12 relative to the magazine carrier 13. Preferably, the feet 36 and/or the foot part 38 are not in contact with the magazine carrier 13. If the first arrangement means 25 determine the position of the receiving body 12, the second arrangement means 26 are ineffective.

An attachment recess 45 each is provided in a first transverse surface 43a of the two transverse surfaces 43. In accordance with the example, each receiving body 12 has a connecting projection 49 on its respectively other, second transverse surface 43b.

For attaching one or more receiving bodies 12 to the magazine carrier 13 of the magazine 10, the procedure is as follows:

An attachment part 46 may engage in the attachment recess 45, said attachment part being fastened to the matrix carrier 13 and screwed thereto, in accordance with the example. In so doing, the attachment part 46 clamps the receiving body 12 in place on the magazine carrier 13. Alternatively to the preferred exemplary embodiment, such attachment parts 46 can also be provided on both opposing transverse surfaces 43 when a single receiving body is being attached to a magazine carrier 13 and come into respective engagement with an attachment recess 45. In accordance with the example, attachment occurs only on one side by means of an attachment part 46.

Even if several receiving bodies 12 are arranged in a row, it is sufficient, in accordance with the example, to attach this row with a single attachment part 46 to the magazine carrier. The first transverse surface 43a and the second transverse surface 43b of two directly adjacent receiving bodies 12 are associated with each other and can be arranged at a minimal distance from each other or abutting against each other, in which case the connecting projection 49 of the respective transverse surface 43b engages in the attachment recess 45 on the adjacent first transverse surface 43a. In so doing, the connecting projection 49 is in contact with a surface 50 of the attachment recess 45, said surface facing away from the magazine carrier 13 (FIG. 8).

For arranging several receiving bodies 12 forming a row, said receiving bodies being in contact with each other with their respective transverse surfaces 43, one attachment part 46 is sufficient in accordance with the example. As described hereinabove, said attachment part is screwed on the accessible first surface 43a of a first receiving body 12 of the row of receiving bodies 12 to the magazine carrier 13. The other receiving bodies 12 of this row are pushed against the magazine carrier 13 via the connecting projections 49.

In order to couple and be able to handle together all the receiving bodies 12 in a row, each of the receiving bodies 12 in the preferred exemplary embodiment has at least one passage opening 47 extending completely through the receiving body 12 at a right angle with respect to its transverse sides 43. The passage openings 47 of the receiving bodies 12 are in alignment when the receiving bodies 12 are in a row, so that a clamping unit 51 can be pushed through a passage of the passage openings 47 (FIGS. 5 and 6), by means of which the receiving bodies 12 can be tensioned relative to each other. In accordance with the example, a clamping screw 52 and a clamping nut 53 act as the clamping unit 51.

Furthermore, referring to the sectional view as in FIG. 7, it can be seen that, between two directly adjacent receiving bodies 12, there are inserted at least one and, in the exemplary embodiment, two fitting keys 54. Each fitting key 54 is partially received in a fitting key recess 55 on the associate first transverse surfaces 43a of the one receiving body 12 and partially in a fitting key recess 55 on the associate second transverse surfaces 43b of the other receiving body. As a result of this, the receiving bodies 12 that are to be coupled can be oriented relative to each other in order to subsequently establish the coupling with the clamping unit 51 through the aligned passage openings 47.

As a result of this, the receiving bodies 12 are combined so that they can be handled as a block, thus facilitating the assembly.

The invention relates to a magazine for storing shaft-shaped workpieces. The magazine 10 comprises at least one receiving body 12 with at least one receiving hole 15 for the insertion of an end section 11a of a shaft-shaped workpiece 11. The end section 11a of a workpiece 11 that has been inserted in a receiving hole 15—viewed along the longitudinal axis L of the workpiece 11—is shorter, and, in particular, shorter by the factors three to five, than the remaining section of the workpiece 11 that adjoins the end section 11a. The receiving body 12 is configured in such a manner that, in operating position of the magazine 10, the center axes M of the at least one receiving hole 15 and the vertical V subtend a first angle of inclination β. As a result of this, it is achieved that the workpieces 11 tilt in a defined tilt direction K and do not hit each other.

### LIST OF REFERENCE SIGNS

### 10 Magazine

### 11 Workpiece

11a End section of the workpiece
12 Receiving body
13 Magazine carrier
14 Receiving section
15 Receiving hole

### 16 Orifice

17 Upper side

### 18 Bottom

25 First arrangement means
26 Second arrangement means
27 Attachment surface
28 Abutment surface

### 29 Underside

30 Positioning means
35 Storage surface

### 36 Foot

37 Free end of the foot
38 Foot part
39 Lateral surface
40 Transverse part
41 End part
42 Attachment part
43 Transverse surface
43a First transverse surface
43b Second transverse surface

### 44 Recess

45 Attachment recess
46 Attachment part
47 Passage opening
48 Clamping element
49 Connecting projection

### 50 Area

51 Clamping unit
52 Clamping screw

### 53 Clamping nut

### 54 Fitting key

55 Fitting key recess
α Tilt angle
β First angle of inclination
γ Second angle of inclination
B1 First reference plane
B2 Second reference plane

### d Distance

E Storage surface plane
F1 First force
F2 Second force
K Tilt direction
L Longitudinal axis
M Center axis

### O Plane

1. Magazine (10) for storing shaft-shaped workpieces (11) for a machine tool, the magazine comprising:
at least one receiving body (12) that has at least one receiving hole (15) for insertion of an end section (11a) of a shaft-shaped workpiece (11), wherein the at least one receiving hole (15) terminates on an upper side (17) of the receiving body (12),
at least one arrangement means (25, 26) disposed on the receiving body (12) for arranging the receiving body (12) on an attachment surface (27) and/or a storage surface (35), wherein the at least one arrangement means (25, 26) defines a reference plane (B1, B2), and
wherein the at least one receiving hole (15) has a center axis (M) that is oriented at an angle of inclination (γ) that is not equal to 90° relative to the reference plane (B1, B2).

2. Magazine as in claim 1, wherein the center axis (M) of the at least one receiving hole (15) is oriented at a right angle with respect to the upper side (17) of the receiving body (12).

3. Magazine as in claim 1, wherein the at least one receiving hole (15) is a pocket hole.

4. Magazine as in claim 1, wherein the at least one receiving hole (15) has a cylindrical contour.

5. Magazine as in claim 1, wherein one or more receiving holes (15) are present in each receiving body (12).

6. Magazine as in claim 4, wherein all receiving holes (15) have a same contour.

7. Magazine as in claim 1, wherein at least one receiving section (14) of the receiving body (12), in which is arranged the at least one receiving hole (15), is made of one piece of a uniform material without seams and joints.

8. Magazine as in claim 1, wherein a first arrangement means (25) for arranging the receiving body (12) on a magazine carrier (13) is provided on the receiving body (12).

9. Magazine as in claim 8, wherein the first arrangement means (25) comprises an abutment surface (28) on an underside (29) of the receiving body (12) opposite the upper side (17), wherein the first reference plane (B1) for the first arrangement means (25) is defined by the abutment surface (28).

10. Magazine as in claim 8, wherein the arrangement means (25) comprises a positioning means (30) that is disposed to determine—together with a positioning counter-means of the magazine carrier (13)—a relative position of the receiving body (12) with respect to the magazine carrier (13).

11. Magazine as in claim 10, wherein at least one positioning projection (31) is provided as the positioning means (30).

12. Magazine as in claim 8, further comprising a second arrangement means (26) for storing the receiving body on a storage surface (35) provided on the receiving body (12).

13. Magazine as in claim 12, wherein the second arrangement means (26) has at least three feet (36) whose free ends are located in a shared storage plane (E), wherein a second reference plane (B2) for the second arrangement means (26) is defined by the storage plane (E).

14. Magazine as in claim 12, wherein the second arrangement means (26) is configured in such a manner that the first arrangement means (25) will not come into contact with the storage surface (35) when the receiving body (12) is placed on a storage surface (35) extending in one plane.

15. Magazine as in claim 13, wherein the first arrangement means (25) comprises one or both of comprises an abutment surface (28) on an underside (29) of the receiving body (12) opposite the upper side (17), wherein the first reference plane (B1) for the first arrangement means (25) is defined by the abutment surface (28), or a positioning means (30) that is disposed to determine—together with a positioning counter-means of the magazine carrier (13)—a relative position of the receiving body (12) with respect to the magazine carrier (13), and wherein the abutment surface (28) and/or the positioning means (30) of the first arrangement means (25) are arranged completely above the storage plane (E).
